(19) United States
(12) Patent Application Publication
(10) Pub. No.: US 2002/0095345 A1
(43) Pub. Date: Jul. 18, 2002

(54) Standing order system and method

(76) Inventors: Edward Panelli, Wauwatosa, WI (US); Charles Neitzel, Kansasville, WI (US); Ajay Berry, Wauwatosa, WI (US); Peng Chen, Brookfield, WI (US); David Gemeinhardt, Milwaukee, WI (US)

Correspondence Address: Patrick S. Yoder, Suite 330, 7915 FM 1960 West, Houston, TX, 77070, US

(21) Appl. No.: 09/682,574

(22) Filed: Sep. 21, 2001

Related U.S. Application Data
(60) Provisional application No. 60/234,726, filed on Sep. 22, 2000.
(60) Provisional application No. 60/234,725, filed on Sep. 22, 2000.

(51) Int. Cl. G06F 17/60

(52) U.S. Cl. 705/26

(57) ABSTRACT

A system and method for enabling a customer to communicate electronically with an electronic information system to create a standing order for the periodic delivery of a desired product, good, or service. The system and method may utilize an electronic information system that is accessible electronically via an electronic communication system. The system and method may utilize a computer program that is operable with processor to enable a customer to create a standing order electronically for the periodic delivery of a product, good, or service.

### BACKGROUND OF INVENTION

This patent application claims priority from provisional patent application No. 90/234,725 and provisional patent application No. 90/234,726, filed on Sep. 22, 2000.

The present invention relates generally to a system and method for creating and managing a standing order, and more particularly, to a system and method to enable a customer to electronically create a standing order with a supplier, the standing order directing the supplier to periodically provide the customer with a desired quantity of products, goods and/or services at a desired frequency of delivery.

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Customers routinely purchase products, goods, and services from a supplier. A customer may purchase desired products, goods, or services from the supplier on an “as needed” is. Other customers, such as manufacturers, have an on-going need for particular products, goods, or services. Consequently, some customers may place a standing order with a supplier to periodically provide the customer with a desired quantity of products, goods, or services.

Additionally, businesses typically use purchase orders when buying or selling products, goods, or services. A purchase order is a written authorization for a supplier to sell products or services at a specified price. The purchase order becomes a legally binding contract once the supplier accepts it. A standing order is a type of purchase order that directs a supplier to provide the customer with a desired product, good, or service in a desired quantity, at a specified price, and at a desired frequency. Once the standing order comes into effect, the supplier is authorized to deliver the desired quantity of products, goods, or services each delivery cycle without having to complete a new purchase order. The supplier simply ships the desired quantities and charges the customer according to the terms of the standing order.

Typically, customers and suppliers communicate verbally or via the mail when establishing purchase orders, such as a standing order. The supplier may need to provide the customer with certain product information to enable the customer to identify the most appropriate product, good, or service to order. These verbal or written exchanges of information may produce volumes of documents to track, are time consuming, create scheduling conflicts, and may result in an inefficient use of time, resources, and money. This is especially true when the customer seeks to make changes to the standing order, such as changing the specific products, goods, or services to be delivered, the quantity of the products, goods, or services to be delivered, or the frequency of the delivery of the products, goods, or services.

A need exists for a technique that reduces or eliminates the problems associated with the conventional methods of creating and managing standing orders. More specifically, there exists a need for a technique that enables a customer to create and manage standing orders electronically using an information system, such as the Internet. The present technique may address one or more of the problems set forth above.

### BRIEF DESCRIPTION OF DRAWINGS

The foregoing and other advantages of the invention may become apparent upon reading the following detailed description and upon reference to the drawings in which:

FIG. 1 is a block diagram of a method of using an electronic communication system to create a standing order in accordance with certain aspects of the present technique;

FIG. 2 is a block diagram of a method for using an electronic communication system to review and/or modify a standing order in accordance with certain aspects of the present technique;

FIG. 3 is a diagrammatic representation of a system operable to create and manage standing orders electronically in accordance with certain aspects of the present technique;

FIG. 4 is a representation of a homepage of an electronic communication system in accordance with certain aspects of the present technique;

FIG. 5 is a representation of a page of an electronic communication system to enable a user to access the electronic communication system in accordance with certain aspects of the present technique;

FIG. 6 is a representation of a page of an electronic communication system to enable a user to input standing order information to the electronic information system in accordance with certain aspects of the present technique;

FIG. 7 is a representation of a page of an electronic communication system to enable a user to review the terms and conditions of the standing order and to enable the user to accept or decline the terms and conditions of the standing order in accordance with certain aspects of the present technique;

FIG. 8 is a representation of a page of an electronic communication system, to enable a user to enter the products, goods, or services they desire to receive in accordance with certain aspects of the present technique;

FIG. 9 is a representation of a page of an electronic communication system to enable a user to confirm the standing order in accordance with certain aspects of the present technique;

FIG. 10 is a representation of a page of an electronic communication system provided to the user to confirm the placement of the standing order in accordance with certain aspects of the present technique;

FIG. 11 is a representation of a page of an electronic communication system to enable a user to select a standing order for review and/or editing in accordance with certain aspects of the present technique;

FIG. 12 is a representation of a page of an electronic communication system to enable a user to review and/or edit a standing order in accordance with certain aspects of the present technique; and

FIG. 13 is a representation of a page of an electronic communication system to confirm revisions made to a standing order in accordance with certain aspects of the present technique.

### DETAILED DESCRIPTION

One or more specific embodiments of the present invention will be described below. In an effort to provide a concise description of these embodiments, not all features of an actual implementation may be described in the specification. It should be appreciated that in the development of any such actual implementation, as in any engineering or design project, numerous implementation-specific decisions are made to achieve the developers” specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

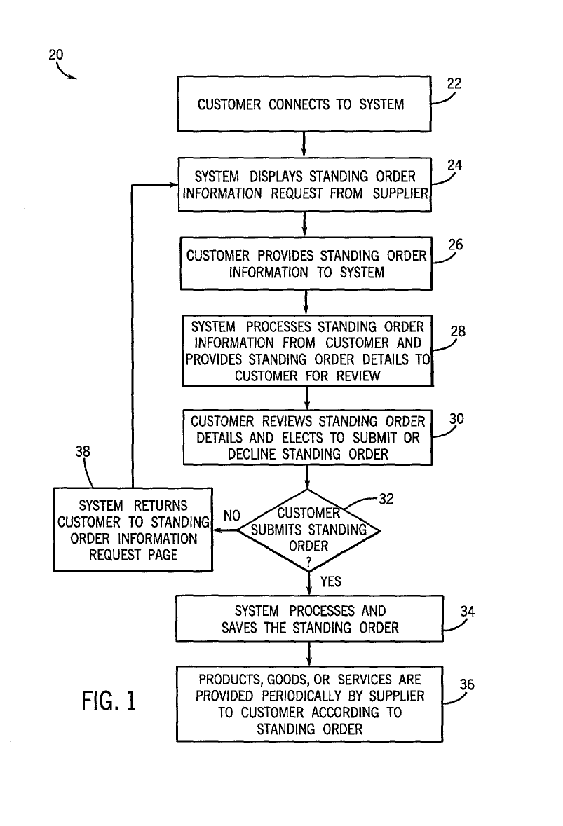

Turning now to the drawings and referring initially to FIG. 1, a process 20 of using an electronic communication system to create a standing order for the delivery of a product, good, or service is illustrated. In the illustrated embodiment, a customer connects to the system, as represented by block 22. The electronic communication system may be connected to the Internet to enable a customer to access the system via the Internet. For security reasons, it may be advantageous that the customer be registered to use the system and to verify their registration before entering portions of the system having confidential information, such as customer account numbers. This prevents an unauthorized user from obtaining access to the confidential information. Once connected to the system, the system may provide the customer with information regarding products, goods, or services, as well as standing orders. For example, the system may have a series of webpages that provide the customer with product, good, or service information.

Additionally, the process 20 includes using the system to elicit information from the customer that is used by the system to create a standing order, as represented by block 24. The system may provide the customer with one or more webpages that are adapted to elicit information from the customer. For example, the system may request that the customer identify a product, good, or service that the customer would like to have delivered periodically under the standing order. The system may request that the customer type in the item number for the desired product, good, or services for placement on a standing order. Alternatively, the system may provide the customer with a link to a catalog where the item numbers are available. Additionally, the system may provide the customer with a list of available products, goods, or services that the customer may select for inclusion in the standing order. The price of the product, good, or service may also be displayed to the customer. The system also may request that the customer provide the length of time that the customer would like the standing order to be in effect. Additionally, the system may request that the customer provide the frequency that the customer would like delivery of the desired products, goods, or services. For example, the system may provide a selection of delivery frequencies from which the customer may select, such as daily, weekly, monthly, quarterly, yearly, etc., or the system may request a desired delivery schedule. The system may also request the customer to provide the start date that the customer would like the standing order to begin.

The system also may provide the customer with a supplier”s terms and conditions for placement of a standing order. Additionally, the system may require that the customer accept the standing order terms and conditions before creating the standing order. The system may also request that the customer provide an existing purchase order number for the standing order.

The process 20 also includes having a customer provide the requested information to the system, as represented by block 26. As discussed above, the customer may enter the information in a variety of ways. For example, the customer may provide the information by selecting from lists or by entering the requested information. More specifically, the customer may select from a list of desired products, goods, or services, or the customer may enter the name or number of a desired product, good, or service. The customer also may provide the desired quantity of product, good, or service desired. The system may request the customer to prompt the system to receive the information.

The system then processes the information and provides the results to the customer for review, as represented by block 28. For example, the system may match a product number with the name of the product and then display that information to the customer. The system also may verify that the product is available for purchase under an order. The system may also calculate a cost for the products, goods, or services under the order. Additionally, the system may include any discounts on the cost of the order. For example, a discount may be provided based on the quantity of products, goods, or services purchased under the order. The discount may increase with the quantity of products, goods, or services purchased. A discount may also be provided based on the duration of the order. The discount may increase with the duration of the term of the standing order.

Additionally, a supplier may have certain business rules for the placement of standing orders. For example, the supplier may request a given quantity of product, goods, or services to be delivered over the life of the standing order. The system may determine the quantity of a product, good, or service desired by the customer for each delivery and the desired frequency of delivery to determine the total quantity of goods to be delivered to the customer under the standing order. If the order cannot be accepted for some reason, e.g., if quantity requested is less than the minimum required for initiating a standing order, the system may send a message to the customer informing the customer that the standing order will not be accepted. The system also may provide the reason for the rejection and the conditions for placement of a standing order. Additionally, if a customer has provided an incorrect product number, the system may inform the customer that an incorrect product number has been entered.

The illustrated process 20 also includes having the customer review the results of the information, as represented by block 30. In the illustrated process 20, the customer has the option of accepting or rejecting the placement of a standing order with the system, as represented by block 32. If the customer accepts placement of the standing order with the system, the system then processes the standing order, as represented by block 34. The customer may accept placement by activating a virtual button indicating that the customer requests placement of the standing order. The system may save the standing order in a database within the system. The system also may send a standing order confirmation to the customer. Additionally, the system may send notification to a warehouse or other facility that processes the standing orders to direct the delivery of the desired products, goods, or services to the customer.

The desired products, goods, or services are then delivered to the customer periodically in accordance with the standing order, as represented by block 36. For example, a warehouse computer may receive an order from the system to deliver the desired products, goods, or services to the customer. The warehouse then responds accordingly to deliver the desired products, goods, or services at the desired frequency.

In the illustrated process 20, if for some reason the customer chooses not to accept placement of the standing order and does not submit a request for a standing order, the customer will be redirected back to an earlier page in the standing order creation process. In the illustrated process 20, the customer is redirected back to the page where the system requested standing order information from the customer if the customer does not submit a request for a standing order when prompted, as represented by block 28. The customer may decline to request a standing order by, for example, operating a virtual button that indicates that the customer is declining the standing order. In the illustrated process 20, the operation of the virtual button directs the system to redirect the customer to the earlier page. The customer may then choose to change, or reenter, their responses to the information requests from the system. Alternatively, the customer may choose not to continue with the creation of the standing order and disconnect from the system.

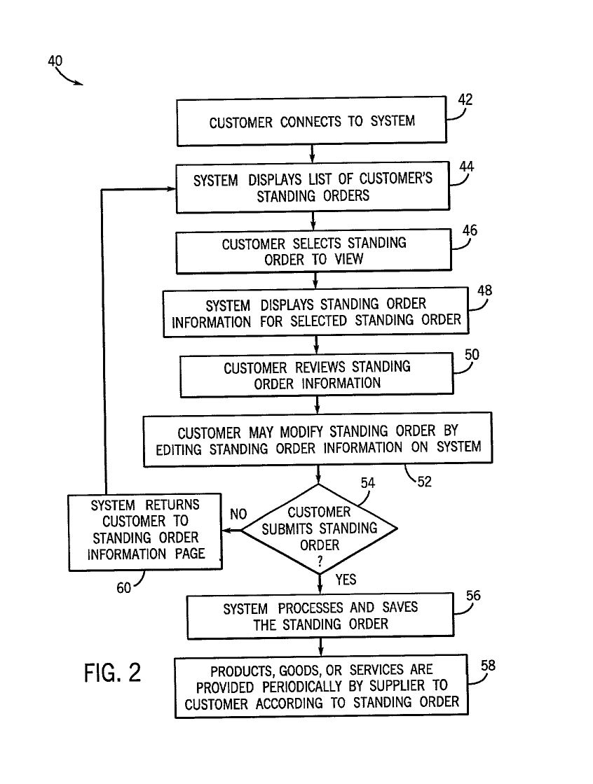

Referring generally to FIG. 2, a process 40 of viewing and/or revising an existing standing order is illustrated. A customer having a standing order may periodically connect to the system, as represented by block 42. Once again, it is typically advantageous that the system be connected to the Internet so that a customer may access the system via the Internet. Also, for security reasons, it may be desired that the customer be registered to use the system and be required to verify that registration before entering any secure portions of the system, such as a customer”s standing order information. The system is operable to authenticate the name and password before allowing the customer to be connected with the secured portions of the system. Once connected to the system, the system may provide the customer with their existing standing order information.

In the illustrated process 40, a customer having a plurality of standing orders is displayed a list of their existing standing orders, as represented by block 44. The customer then selects the desired standing order from the list for review and/or editing, as represented by block 46. The system then provides the existing information for the selected standing order to the customer, as represented by block 48. Alternatively, the details of all standing orders may be displayed at once for review and/or editing.

A customer may review the existing standing order information as part of the process 40, as represented by block 52. If the customer desires to change the standing order, the customer may then do so, as represented by block 52. For example, the system may allow the customer to change the frequency or quantities of the products, goods, or services to be delivered under the standing order. Additionally, the system may allow the customer to add or delete products, goods, or services to be delivered under the standing order.

The edited information is then provided to the system. The system processes the information and may provide the results to the customer for review. The system may inform the customer if incorrect information was provided or if the requested changes to the standing order violate the terms and conditions of the standing order. For example, if the order cannot be accepted for some reason, e.g., if the quantity of products to be delivered is now less than the minimum required for the standing order, the system may send a message to the customer informing the customer that the standing order revision will not be accepted. The system also may provide the reason for the rejection and the conditions for placement of a standing order. The system may also calculate the new cost for the products, goods, or services under the standing order, according to the changes to the standing order. Additionally, the system may recalculate any discounts on the cost of the products, goods, or services under the order. Changing the length of the standing order also may alter the available discount based on the duration of the order, so the system may recalculate this discount, as well.

The customer may then submit the revised standing order to the system, as represented by block 54. If the system accepts the revised standing order, the system then processes the standing order, as represented by block 56. The customer may submit the revised standing order by activating a virtual button indicating that the customer requests placement of the standing order. The system may save the revised standing order in a database within the system. The system also may send a standing order confirmation to the customer. Additionally, the system may send notification to a warehouse or other facility that processes the standing orders to direct the delivery of the desired products, goods, or services according to the customer according to the revised standing order. The desired products, goods, or services are then sent to the customer periodically in accordance with the standing order, as represented by block 58.

If for some reason the customer chooses not to submit the revised standing order, the customer will be redirected back to an earlier page in the standing order creation process, as represented by block 60. The customer may decline to submit the revised standing order by operating a virtual button that indicates to the system that the customer is declining the revised standing order. The operation of the virtual button directs the system to redirect the customer to the earlier page. The customer then may choose to change, or reenter, their revisions to the standing order. Alternatively, the customer may choose not to continue with the creation of the standing order and disconnect from the system.

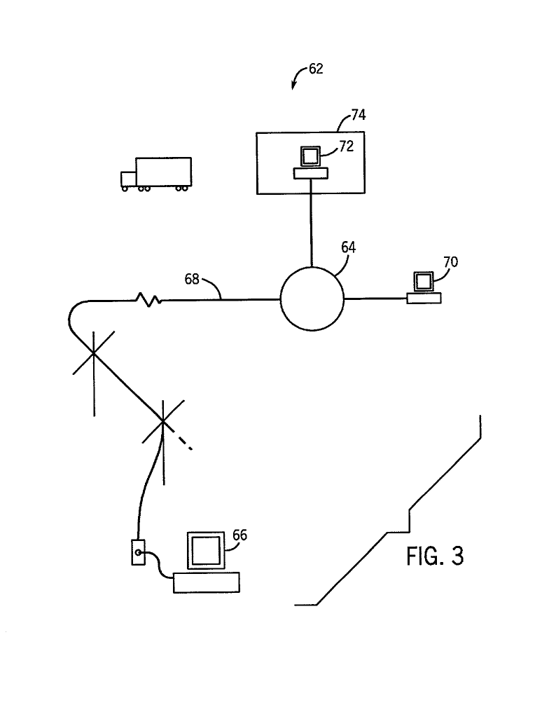

Referring generally to FIG. 3, a system 62 is illustrated that enables a customer to use an electronic information system 64 to create and manage standing orders for products, goods, or services. The electronic information system 64 may include a server, or servers, connected to the Internet or some other communication network. A server typically includes a processor that operates in accordance with programming instructions stored in memory, such as a hard drive. The electronic information system 64 also may include a communication device, such as a modem, that enables the information system 64 to communicate electronically with computers and other electronic devices. The electronic information system 64 has at least one computer program stored in memory that provides a processor, or processors, within the system 64 with programming instructions to enable the electronic information system 64 to receive, process, and store standing orders from the customer electronically, as described above. Specifically, the computer program may enable the electronic information system 64 to enable a customer to create, review, and/or revise a standing order. Also, the computer program may enable an operator to program the electronic information system 64 to process standing orders according to desired rules, for example, a supplier”s rules for minimum quantities of products, goods, or services, to be ordered under the standing order.

In the illustrated embodiment, a customer may use a computer to connect to the system 64 via the Internet. The customer may use a telephone line 68 to connect to the system, as illustrated, or another method of communication, such as a wireless telephone system, a cable TV system, or a satellite communication system. Additionally, a customer may use a communication device, other than a personal computer, to connect to the electronic communication system 64.

For example, a customer may use a palm computer or a personal digital assistant to connect to the system 64. The electronic information system 64 provides the customer with at least one interactive page which enables the customer to input information to the electronic information system 64. In one example, the page provides the customer with at least one query intended to elicit desired information from the customer to create the standing order.

A supplier also may connect to the electronic communication system 64 via a computer 70. The supplier may desire to connect to the electronic information system 64 for a variety of reasons. For example, a system operator may use the computer 70 to manage the electronic information system 64 or supplier may use the computer 70 to manage the standing orders received by the electronic communication system 64. The electronic information system 64 may also include a second computer 72 located at a warehouse or service center 74. The illustrated electronic information system 64 is operable to enable the first computer 70 to communicate via the electronic information system 64 with the second computer 72 at the warehouse 74. This enables the first computer 70 to direct the delivery of products and goods from the warehouse or service center 74 to the customer. Alternatively, the electronic information system 64 may provide the information directly to the warehouse computer 72.

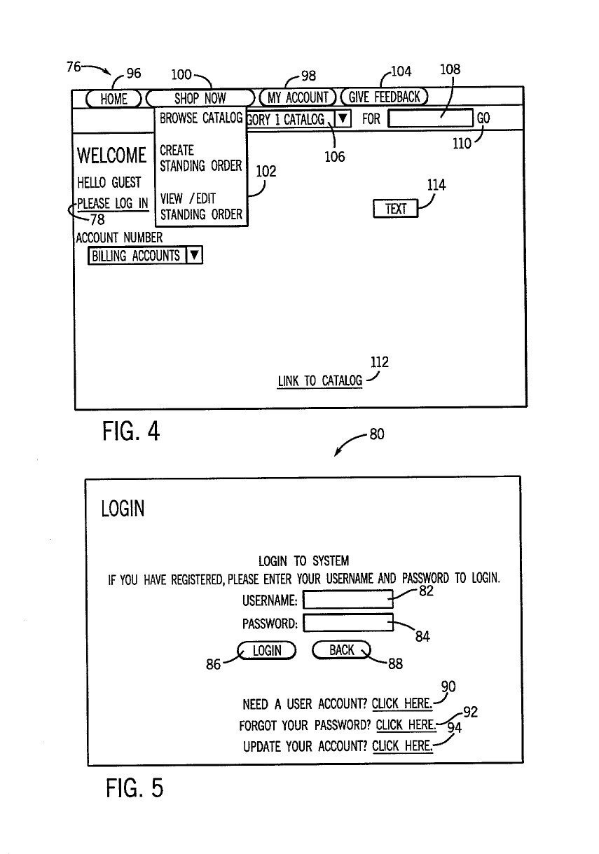

Referring generally to FIG. 4, an exemplary homepage 76 for a website operable to enable a customer to create or revise a standing order for a desired product, good, or service is illustrated. A customer accessing the electronic information system 64 with a desktop computer may have the illustrated homepage 76 displayed on the desktop computer”s monitor. A customer accessing the system with another type of device, such as a handheld computer, may have a different image displayed on their device.

The illustrated homepage 76 may include a statement welcoming the customer to the website. The homepage 76 also may include a link 78 to an authorization page 80. The authorization page 80 is adapted to elicit information from the customer to ensure that the customer is authorized to use the electronic information system to create or revise a standing order. In the illustrated embodiment, the link 78 includes a textual statement requesting the customer to “Please log in.” When the link 78 is activated, a customer is redirected to the authorization page 80, as illustrated in FIG. 5. The authorization page 80 has a user name entry block 82 adapted to elicit the user name from the customer. Additionally, the authorization page 80 has a password entry block 84 adapted to elicit the password from the customer. The customer may initially obtain their user name and password from a supplier”s representative. Alternatively, the electronic information system 64 may be adapted to enable a customer to obtain a unique user name and password via the system 64. The user name and password, however derived, are stored in memory in the electronic information system 64.

Once the customer has entered the information into the user name and password entry blocks respectively, a customer may activate a login button 86 to submit the information to the electronic information system 64. The electronic information system 64 compares the user name and password provided by the customer with the user name and password stored in memory. If the user name and password match, the customer is authorized to use the electronic information system 64 to create a standing order. Alternatively, a back button 88 enables a customer to return to the previous page if the customer determines that they do not want to, or cannot, login to the electronic information system 64. The authorization page 80 may have other features, such as link 90 to a page to enable a new user to create an account, a link 92 to enable a user to request their password if the password has been forgotten or lost, and a link 94 to a page that enables a user to update their account.

Referring again to FIG. 4, a number of virtual buttons are displayed on each page to enable a customer to direct the electronic information system to initiate certain actions. For example, the illustrated page has a home button 96 which, when activated, directs the electronic information system to connect the customer with the homepage 76. The illustrated page also has an account button 98 which, when activated, directs the electronic information system to provide the customer with a page displaying the customer”s account information. Additionally, the illustrated page has a shop button 100 which, when activated, directs the electronic information system to produce a menu 102 of shopping options. In the illustrated menu 102, a customer may select the option of browsing the catalog, creating a standing order, or viewing/editing a standing order. The illustrated page also has a feedback button 104 which, when activated, directs the system to open an e-mail program to enable a customer to e-mail a supplier”s representative to provide the supplier with customer feedback.

The illustrated page may also have a number of other features. For example, the electronic information system may include a search engine which enables a customer to search the website for keywords. In the illustrated embodiment, the search engine is operated by selecting from a search menu 106 a portion of the website to be searched, or the entire website. A keyword to search for is then placed within a search window 108. A search button 110 is activated to initiate a search of the selected portions of the website. The illustrated page may also have a link 112 to a catalog. When the link is activated, the electronic information system 64 displays an online catalog of available products, goods, or services. The page also has text 114 to provide information directly to the customer.

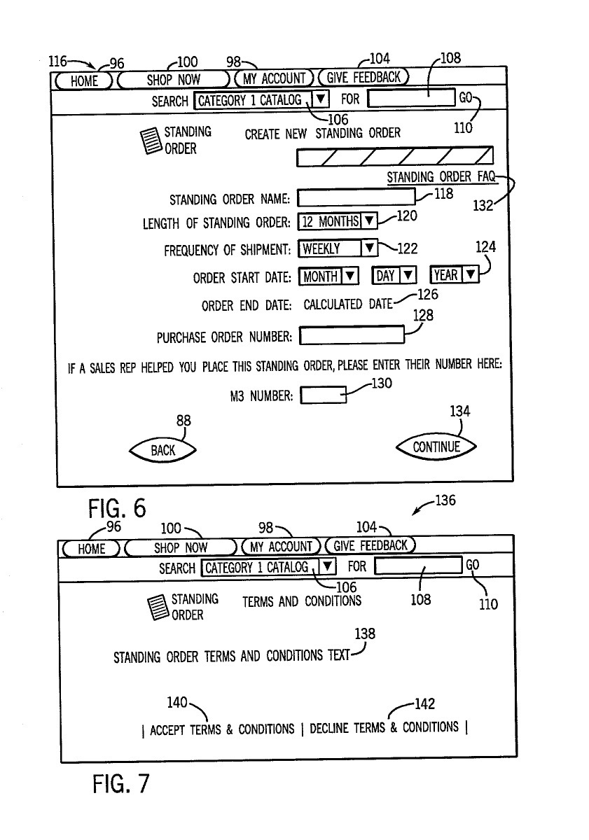

Referring to FIG. 6, when a customer selects the option of creating a standing order, the electronic information system 64 provides the customer with a standing order creation page 116.

The illustrated standing order creation page 116 has a number of features that assist a customer in creating a standing order with a supplier for the periodic delivery of products, goods, or services. For example, the illustrated standing order creation page 116 has a name box 118 to enable a customer to attach a name to the standing order. The illustrated standing order creation page 116 also provides the customer with a length of standing order menu 120 to enable a customer to select the period of time that the customer desires the standing order to be in effect.

The illustrated length of standing order menu 120 is a pull down menu having a number of options for the length of time the customer desires to have the standing order in place, such as: a month, a quarter, a year, etc.

The illustrated standing order creation page 116 also has a frequency of shipment menu 122 to enable a customer to select the desired frequency of delivery of the products, goods, or services to be delivered under the standing order. The illustrated frequency of shipment menu 122 is a pull down menu having a number of options for the frequency of delivery of the products, goods, or services, such as weekly, monthly, quarterly, yearly, etc.

The illustrated standing order creation page 116 also has a standing order start date menu 124 to enable a customer to select the desired starting date for the delivery of the products, goods, or services to be delivered under the standing order. The illustrated standing order start date menu 124 is a series of pull down menus for the month, day, and year for the customer to select the desired starting date for the standing order to begin. The electronic information system 64 is operable to calculate the standing order end date based on the starting date information and the length of time of the standing order information provided by the customer. The electronic information system is operable to inform the customer via a standing order end date message box 126 on the standing order creation page 116.

The illustrated standing order creation page 116 also has a purchase order number box 128 to enable a customer to provide a purchase order number associated with the customer. The purchase order information is used by the electronic information system 64 in billing the customer for the products, goods, or services delivered under the standing order. The standing order creation page 116 also has a sales rep box 130 to enable a customer to attach a supplier”s sales representative name or number to the standing order. The standing order creation page 116 may also have a link 132 to a page (not shown) containing frequently asked questions regarding standing orders and the answers to the questions.

The illustrated standing order creation page 116 also has a continue button 134 which, when activated, directs the electronic information system 64 to connect the customer to another page to continue in the creation of the standing order. Referring generally to FIG. 7, in the illustrated embodiment, a customer activating the continue button 134 is connected to a terms and conditions page 136. The terms and conditions page 136 displays the text 138 of the terms and conditions under which the supplier will create a standing order with the customer. An acceptance button 140 is provided to enable a customer to accept the supplier”s terms and conditions. Additionally, a decline button 142 is provided to enable a customer to decline, or reject, the supplier”s terms and conditions. Activating the decline button 42 directs the electronic information system 64 to connect the customer to another page, such as the standing order creation page 116.

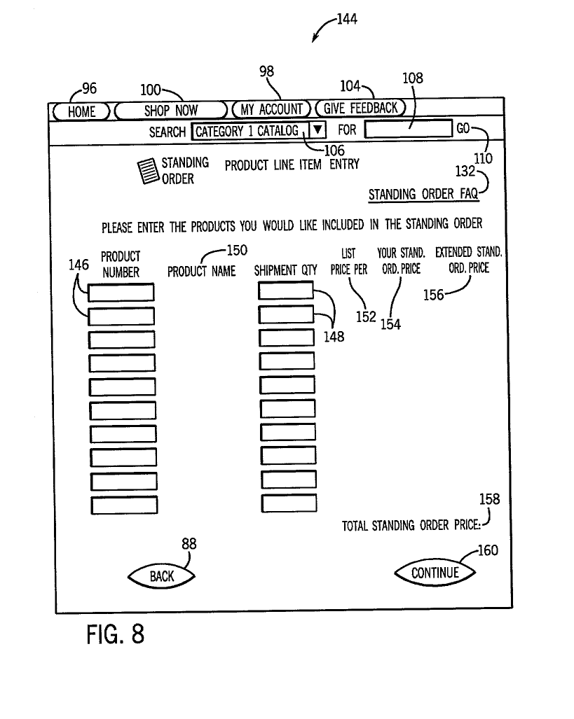

Referring to FIG. 8, in the illustrated embodiment, a customer activating the acceptance button 140 is connected to a standing order entry page 144. The illustrated entry page 144 has a plurality of product boxes 146 to enable a customer to input the number of each of the desired products, goods, or services desired by the customer to be delivered under the standing order. The illustrated entry page also has a series of quantity boxes 148 to enable a customer to order a desired quantity of each of the desired product, goods, or services to be delivered with each delivery.

In turn, the electronic information system 64 identifies the product, good, or service by the number and provides the customer with the product name in a column of product names 150. The customer may then verify that the correct number was provided for the product, good, or service. Additionally, the electronic information system 64 provides the customer with the list price for each item in a column of list prices 152. Further, in the illustrated embodiment, the electronic information system 64 may be programmed by the supplier to provide the customer with a discount from the list price if ordering the product, good, or service as part of a standing order. The electronic information system 64 calculates the discount and then displays the discounted price for each item in a discount price column 154. The discount may vary depending on a number of factors, such as the duration of the standing order or the quantity of products, goods, or services purchased. The electronic information system 64 may also calculate the extended price for each product, good, or service based on the discounted price, if applicable, and the quantity ordered. The extended price for each item is displayed by the electronic information system 64 in an extended price column 156. Finally, in the illustrated embodiment, the electronic information system calculates a total price for the standing order and then displays the amount in a total standing order price box 158.

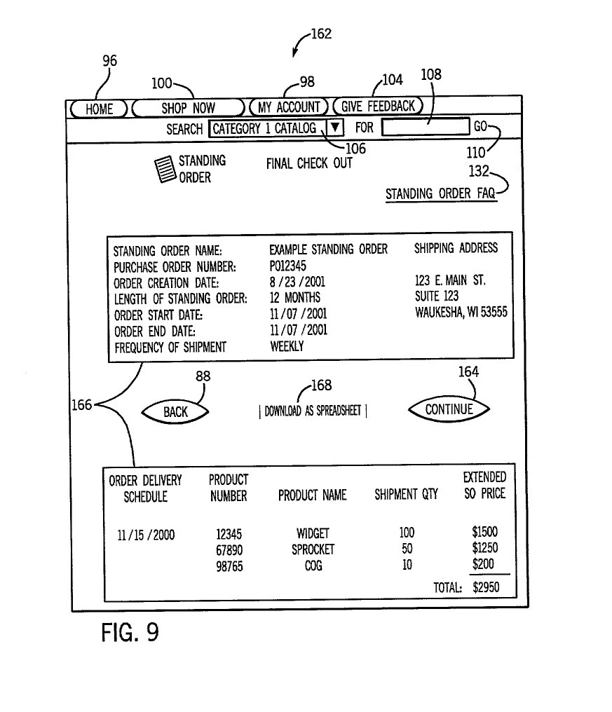

To continue the process of creating the standing order, a continue button 160 is provided to direct the electronic information system 64 to connect the customer to another page to continue in the creation of the standing order. Referring to FIG. 9, in the illustrated embodiment, a customer activating the continue button 160 on the standing order entry page 144 is connected to a final checkout page 162. The final checkout page 162 enables the customer review the information regarding the standing order before actually submitting the standing order to the electronic information system 64. A confirmation button 164 is provided to enable the customer to confirm that the information is correct and to submit the standing order to the electronic information system 64.

As another advantageous feature, the electronic information system 64 may enable the standing order information 166 to be downloaded to a customer”s computer 66. A download button 168, when activated, directs the electronic information system 64 to download the standing order information 166 to the customer”s computer 66. The standing order information 166 may be downloaded as a spreadsheet, or some other format, such as a word processing or database format.

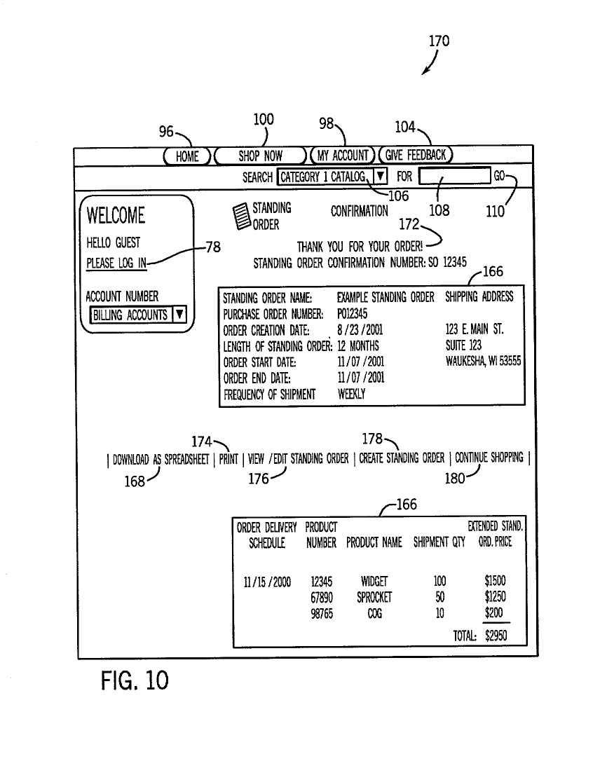

Referring generally to FIG. 10, in the illustrated embodiment, a customer activating the confirmation button 164 on the final checkout page 162 is connected to a confirmation page 170. In the illustrated embodiment, the electronic information system 64 processes the request for a standing order, stores the standing order information, and displays a confirmation number for the standing order in a confirmation number box 172. A print button 174 is provided to enable the customer to print out the confirmation page 170. A customer may review or edit existing standing orders with a review/edit button 176. A customer may create another standing order by activating a create standing order button 178. For example, a customer may be connected to a new standing order creation page 116 when the create standing order button 178 is activated. Alternatively, a customer may shop on the website for other products, goods, and services by activating a continue shopping button 180.

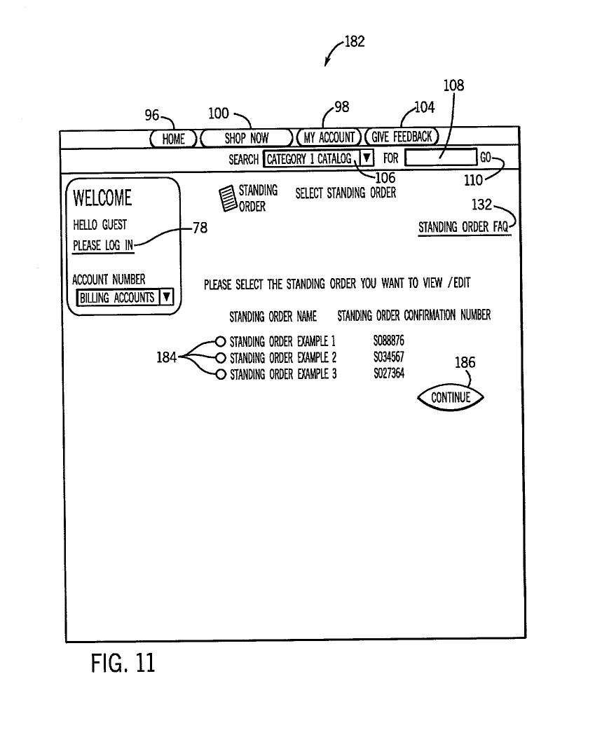

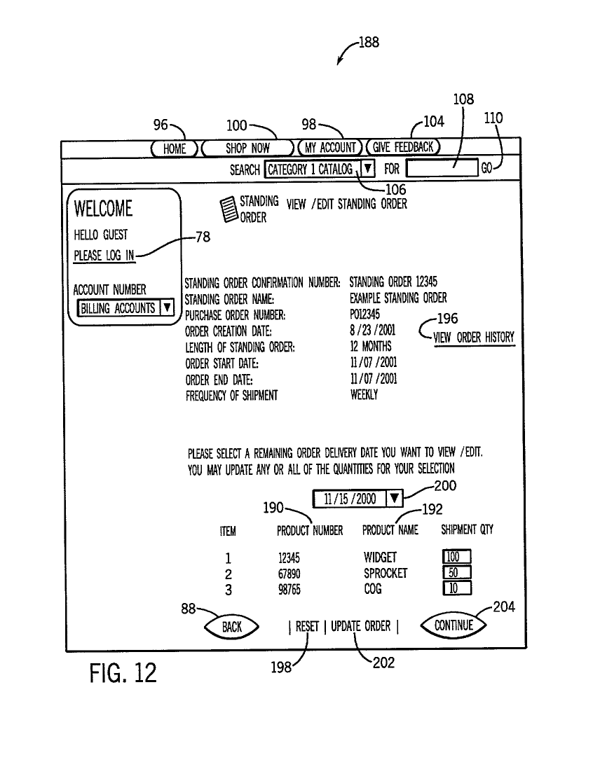

Referring to FIG. 11, when a customer connected to the homepage 76 selects the option of viewing/editing a standing order from the shop now menu 100, the electronic information system 64 connects the customer to a standing order selection page 182. The illustrated standing order selection page 182 enables a customer with a plurality of existing standing orders to select the desired standing order for review and/or editing. In the illustrated embodiment, the standing orders are displayed by standing order name and confirmation number. Each standing order has a selection box 184. One or more of the standing order boxes may be selected. Additionally, the selection page 182 has a continue button 186 to direct the electronic information system 64 to access the standing order information for the selected standing order, or orders, Referring to FIG. 12, when the continue button 186 is activated, the electronic information system 64 accesses the standing order information for the selected standing order, or orders, and displays the standing order information in a review/edit page 188. A customer may review the existing information for the standing order. For example, in the illustrated embodiment, each product, good or service to be delivered under the standing order is listed by number 190 and name 192. The quantity to be delivered for each item is displayed in a shipment quantity box 194. Additionally, in the illustrated embodiment, a link 196 to the standing order history is provided. When the link 196 is activated, a page (not shown) containing the history of the standing order, such as the items delivered, delivery dates, etc., is displayed.

A customer also may use the electronic information system 64 to edit or revise the information in the standing order. For example, the review/edit page 188 enables a customer to direct the electronic information system to change the quantity of a product, good, or service to be delivered. Initially, the shipment quantity box 194 reflects the existing quantity information stored in the electronic information system 64. However, a customer may input new information in the shipment quantity box 194. In the illustrated embodiment, a reset button 198 is provided to enable a customer to direct the electronic information system 64 to reset the values in the quantity boxes 194. Additionally, in the illustrated embodiment, the shipment quantity for a specific product, good, or service for a specific shipment date may be changed. The review/edit page 188 has a delivery date menu 200 which may be activated to select a specific delivery date for editing. Also, new items may be added to the standing order.

An update button 202 is provided to enable a customer to direct the electronic information system 64 to update, e.g., process and store, the edited information. Additionally, the electronic information system 64 is operable to compare the edited data with the business rules stored in the electronic information system 64. If the edited information conflicts with the business rules, the electronic information system 64 may reject the edited standing order. The electronic information system 64 may inform the customer of the conflict and allow the customer to re-edit the information in the standing order.

The review/edit page 188 may have a continue button 204 to direct the electronic information system 64 to continue to the next page of the review/editing process. The continue button 204, rather than the update button 202, may enable a customer to direct the electronic information system 64 to process and/or store the edited information. Additionally, the edited data may be compared with the business rules stored in the electronic information system 64 to identify any conflicts with the business rules.

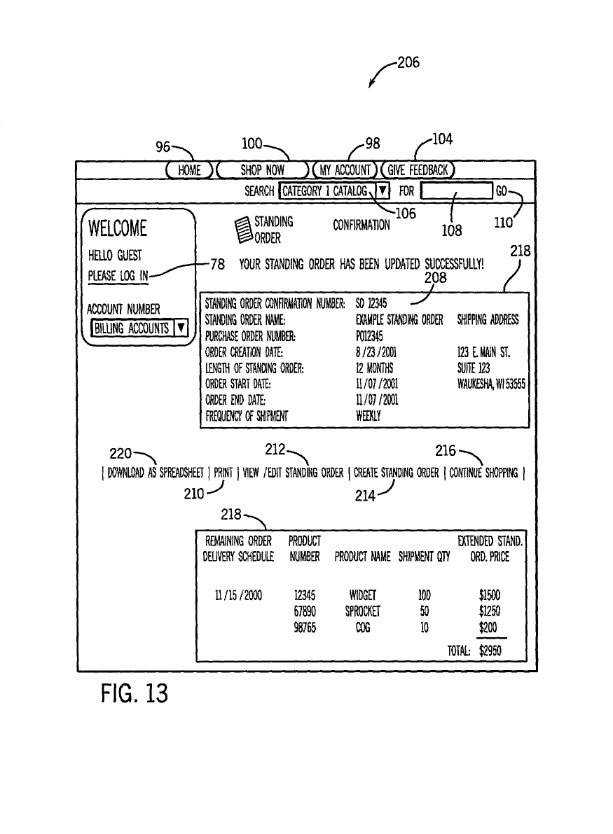

Referring to FIG. 13, in the illustrated embodiment, a customer activating the continue button 204 on the review/edit page 188 is connected to a confirmation page 206. In the illustrated embodiment, the electronic information system 64 processes the edited request for a standing order, stores the standing order information, and displays a confirmation number for the standing order in a confirmation number box 208. Additionally, a print button 210 is provided to enable the customer to print out the confirmation page 206. A customer may review or edit existing standing orders with a review/edit button 212. Further, a customer may create another standing order by activating a create standing order button 214. For example, a customer may be connected to a new standing order creation page 116 when the create standing order button 214 is activated. Alternatively, a customer may shop on the website for other products, goods, and services by activating a continue shopping button 216.

The electronic information system 64 may enable the standing order information 218 to be downloaded to a customer”s computer 66. A download button 218, when activated, directs the electronic information system 64 to download the standing order information 218 to the customer”s computer 66. The standing order information 218 may be downloaded as a spreadsheet, or some other format, such as a word processing or database format.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An electronic information system, wherein the electronic information system is accessible electronically via an electronic communication system, wherein the electronic information system is operable to enable a customer to access the electronic information system via the electronic communication system to create a standing order electronically for periodic delivery of a product, good, or service.

2. The system as recited in claim 1, wherein the electronic communication system comprises the Internet.

3. The system as recited in claim 1, wherein the electronic information system is operable to enable the customer to access the electronic information system via the electronic communication system and identify electronically the product, good, or service to be delivered periodically under the standing order.

4. The system as recited in claim 1, wherein the electronic information system is operable to enable the customer to access the electronic information system via the electronic communication system to select the product, good, or service to be delivered periodically under the standing order from a selection of products, goods, or services provided by a supplier.

5. The system as recited in claim 4, wherein the electronic information system enables the customer to access the electronic information system via the electronic communication system to revise the product, good, or service to be delivered periodically under the standing order.

6. The system as recited in claim 1, wherein the electronic information system is operable to enable the customer to access the electronic information system via the electronic communication system and order a desired quantity of the product, good, or service to be delivered periodically under the standing order.

7. The system as recited in claim 6, wherein the electronic information system enables the customer to access the electronic information system via the electronic communication system and revise the desired quantity of the product, good, or service to be delivered periodically under the standing order.

8. The system as recited in claim 1, wherein the electronic information system is operable to enable the customer to access the electronic information system via the electronic communication system and establish a desired frequency of delivery of the product, good, or service to be delivered periodically under the standing order.

9. The system as recited in claim 8, wherein the electronic information system enables the customer to access the electronic information system via the electronic communication system to revise the desired frequency of delivery of the product, good, or service to be delivered periodically under the standing order.

10. The system as recited in claim 1, wherein the electronic information system is operable to enable the customer to access the electronic information system via the electronic communication system and establish a desired duration of the standing order.

11. The system as recited in claim 1, comprising:
at least one processor electrically coupled to the electronic communication system; and
a computer program stored in memory, wherein the computer program and processor are operable to enable the electronic information system to communicate electronically with the customer to create the standing order.

12. The system as recited in claim 11, wherein the electronic information system requires the customer to provide an authorization identifier before enabling the customer to create the standing order.

13. The system as recited in claim 1, wherein the electronic information system provides the customer accessing the electronic information system with an interactive visual interface.

14. The system as recited in claim 1, wherein the electronic information system is operable to enable the customer to access the electronic information system via the electronic communication system to review a standing order for periodic delivery of a product, good, or service.

15. The system as recited in claim 1, wherein the electronic information system is operable to enable a supplier to direct the periodic delivery of the product, good, or service.

16. The system as recited in claim 1, wherein the electronic information system incorporates business rules provided by a supplier for the creation of a standing order, wherein the electronic information system prevents the customer from creating a standing order in violation of the business rules.

17. A computer program stored in a tangible medium, wherein the computer program enables an electronic information system to communicate electronically with the customer to create a standing order for periodic delivery of a desired product, good, or service.

18. The computer program as recited in claim 17, wherein the computer program enables the customer to communicate electronically with the electronic information system to revise the standing order.

19. A computer program stored in a tangible medium, wherein the computer program enables an electronic information system to enable a customer to access the electronic information system and input electronically a desired product, good, or service for periodic delivery under a standing order.

20. The computer program as recited in claim 19, wherein the computer program enables the electronic information system to enable the customer to access the electronic information system and input electronically a frequency of delivery for the desired product, good, or service.

21. The computer program as recited in claim 19, wherein the computer program enables the electronic information system to enable the customer to access the electronic information system and input electronically a quantity of the desired product, good, or service for periodic delivery under the standing order.

22. The computer program as recited in claim 19, wherein the computer program enables the electronic information system to enable the customer to access the electronic information system and review the standing order.

23. The computer program as recited in claim 19, wherein the computer program enables the electronic information system to enable the customer to access the electronic information system and input revisions to the standing order electronically.

24. The computer program as recited in claim 19, wherein the computer program enables a supplier”s business rules to be incorporated into the electronic information system to prevent the electronic information system from creating a standing order in violation of the supplier”s business rules.

25. A method for providing a customer with a desired product, good, or service on a periodic basis, comprising the acts of:
providing an electronic information system to enable the customer to electronically place a standing order for periodic delivery of a desired product good, or service with a supplier; and
delivering the desired product, good, or service to the customer on a periodic basis.

26. The method as recited in claim 25, further comprising the act of:
adapting the electronic information system to enable the customer to access the electronic information system and review the standing order.

27. The method as recited in claim 25, further comprising the act of:
adapting the electronic information system to enable the customer to access the electronic information system and modify the standing order.

28. The method as recited in claim 27, wherein modify the standing order comprises changing a quantity of a product, good, or service to be delivered under the standing order.

29. The method as recited in claim 27, wherein modify the standing order comprises changing the product, good, or service to be delivered under the standing order.

30. A system, comprising:
a memory;
a computer program stored in the memory,
a processor coupled to the memory, the processor operating in response to the computer program stored in memory; and
an electronic communication system coupled to the processor;
wherein the computer program enables a customer to access the system electronically via the electronic communication device and order a quantity of a product, good, or service for delivery by a supplier on a periodic basis.

31. The system as recited in claim 30, wherein the electronic communication system enables the customer to access the system via the Internet.

32. The system as recited in claim 30, wherein the computer program enables the customer to access the system electronically via the electronic communication system and establish the periodic basis for delivery of the product, good, or service ordered.

33. The system as recited in claim 30, wherein the computer program enables the customer to access the system electronically via the electronic communication device and establish the periodic basis for delivery of the product, good, or service ordered.

34. The system as recited in claim 30, wherein the computer program provides the customer accessing the system with an interactive visual interface adapted to direct the customer through a process of ordering the quantity of a product, good, or service for delivery by a supplier on a periodic basis.

35. The system as recited in claim 30, wherein the system is operable to enable the customer to access the electronically via the electronic communication system to change the quantity of a product, good, or service for delivery by a supplier on a periodic basis.

36. The system as recited in claim 35, wherein the system is operable to enable the customer to access the electronically via the electronic communication device to change the periodic basis for delivery of the quantity of a product, good, or service.

37. The system as recited in claim 30, wherein a supplier”s rules for ordering products, goods, or services, are stored in memory, further wherein the system prevents the customer from ordering the quantity of a product, good, or service in violation of the supplier”s rules.

38. A system to enable a customer order a product, good, or service from a supplier, comprising:
means for enabling the customer to communicate electronically with an electronic order processing system; and
means for enabling the customer create an order electronically with the electronic order processing system for periodic delivery of a desired product, good, or service.

39. The system as recited in claim 38, comprising:
means for revising the order electronically.

40. The system as recited in claim 38, comprising:
means for the periodic delivery of the desired product, good, or service.

41. A method of operating an electronic information system, comprising the acts of:
enabling a customer to access the electronic information system electronically; and
executing a computer program within the electronic information system to enable a customer accessing the electronic information system to create a standing order for the periodic delivery of a desired product, good, or service.

42. The method as recited in claim 41, comprising the act of eliciting information from the customer electronically to create the standing order.

43. The method as recited in claim 42, wherein eliciting information comprises receiving a request for a desired product, good, or service from the customer for delivery under the standing order.

44. The method as recited in claim 43, wherein eliciting information comprises receiving a request for a desired quantity of the desired product, good, or service from the customer for delivery under the standing order.

45. The method as recited in claim 42, wherein eliciting information comprises receiving a request for a desired frequency of delivery of a desired product, good, or service from the customer under the standing order.

46. The method as recited in claim 42, wherein eliciting information comprises receiving a request for a desired duration of delivery of a desired product, good, or service under the standing order from the customer.

47. A method of using an electronic information system, comprising the acts of:
accessing the electronic information system electronically; and
providing information to the electronic information system electronically to enable the electronic information system create a standing order for the periodic delivery of a desired product, good, or service.

48. The method as recited in claim 47, wherein accessing comprises communicating with the electronic information system electronically using the Internet.

49. The method as recited in claim 47, wherein providing information comprises the act of responding to requests for information from the electronic information system.

50. The method as recited in claim 47, further comprising the act of accessing the electronic information system to revise the information provided to the electronic information system.

51. A method of operating an electronic information system, comprising the acts of:
enabling a customer to connect to the electronic information system electronically;
providing a request for standing order information to the customer;
receiving standing order information from the customer;
processing the standing order information to produce a standing order request for the periodic delivery of a desired product, good, or service;
providing the standing order request to the customer for review;
enabling the customer submit the standing order request to the electronic information system; and
processing the standing order request submitted to the electronic information system.

52. The method as recited in claim 51, comprising the acts of:
enabling a customer to reconnect to the electronic information system electronically;
providing the customer with information regarding an existing standing order;
enabling the customer to produce a revised standing order from the existing standing order;
processing the revised standing order.

53. A method of using an electronic information system, comprising the acts of:
connecting to the electronic information system electronically;
receiving a request for standing order information for the periodic delivery of a desired product, good, or service from the electronic information system;
responding to the request for standing order information with requested standing order information;
reviewing processed standing order information from the electronic information system; and
submitting a request for a standing order to the electronic information system.

54. The method as recited in claim 53, comprising the acts of:
reconnecting to the electronic information system electronically;
reviewing existing standing order information for the periodic delivery of a desired product, good, or service received from the electronic information system; revising the standing order; and
submitting a revised request for a standing order to the electronic information system.
